(19) United States
(12) Patent Application Publication
(10) Pub. No.: US 2019/0126399 A1
(43) Pub. Date: May 2, 2019

(54) LASER-WELDING APPARATUS AND LASER-WELDING METHOD

(71) Applicant: PANASONIC INTELLECTUAL PROPERTY MANAGEMENT CO., LTD., Osaka (JP)

(72) Inventor: Takashi URASHIMA, Osaka (JP)

(73) Assignee: PANASONIC INTELLECTUAL PROPERTY MANAGEMENT CO., LTD., Osaka (JP)

(21) Appl. No.: 16/170,450

(22) Filed: Oct. 25, 2018

(30) Foreign Application Priority Data
Oct. 26, 2017 (JP) 2017-207502

(51) Int. Cl. B23K 26/24

(52) U.S. Cl. CPC B23K 26/24

(57) ABSTRACT

A laser-welding apparatus is disclosed, which includes: a laser output section that emits a laser beam; a measurement beam source that outputs a measurement beam having a wavelength different from that of the laser beam and periodically changes the wavelength of the measurement beam when outputting the measurement beam; an optical member that irradiates a weld part with the laser beam and the measurement beam from the measurement beam source while coaxially overlapping the laser beam and the measurement beam with each other; and an optical interferometer that measures a keyhole depth of the weld part based on interference which occurs due to an optical path difference between the measurement beam reflected by the weld part, and a reference beam, in which an average of a scanning speed of an optical frequency in the measurement beam source is greater than or equal to 2000 PHz per second.

### CROSS REFERENCE TO RELATED APPLICATIONS

This application is entitled to and claims the benefit of Japanese Patent Application No. 2017-207502, filed on Oct. 26, 2017, the disclosure of which including the specification, drawings and abstract is incorporated herein by reference in its entirety.

### TECHNICAL FIELD

The present invention relates to a laser-welding apparatus and a laser-welding method for evaluating quality of a weld part in welding using a laser beam.

### BACKGROUND ART

As a traditional welding apparatus, there is a laser-welding apparatus which performs evaluation of a weld part by directly measuring a depth of a keyhole generated during welding.

More specifically, as illustrated in FIG. 6, in laser-welding apparatus 100, a welding laser beam is outputted from laser oscillator 102 and directed to weld part 105 of welding-target member 104 via weld head 103 during a welding process. Melting and evaporation from an upper portion of weld part 105 irradiated with the laser beam forms molten puddle 106 which is generated by melting of a metallic member of weld part 105, and also forms keyhole 107 which is a cavity generated by pressure of the vaporized metal.

During this welding process, measurement beam source 108 continuously outputs a measurement beam of a wavelength different from that of a welding laser beam. Measurement beam source 108 periodically changes the wavelength of the measurement beam to be outputted. The measurement beam is transmitted to weld head 103 via optical interferometer 109 and optical fiber 110, and is directed to keyhole 107 of weld part 105 while being concentrically and coaxially overlapped with the welding laser beam by beam splitter 111.

The measurement beam which has been reflected by keyhole 107 is inputted again to optical interferometer 109 via optical fiber 110. In optical interferometer 109, a beam which has passed through reference optical path 112 and the measurement beam which has been reflected by keyhole 107 are combined to form an interference beam. The interference beam is converted by detector 113 into a signal indicating intensity.

Calculator 114 obtains a position where the measurement beam has been reflected by keyhole 107, using the principle of Swept Source Optical Coherence Tomography (SS-OCT: wavelength-scanning optical interference tomography), based on the signal resulting from the conversion by detector 113. This allows a depth of the keyhole to be measured during a welding process. Since the depth of keyhole 107 has a correlation with a weld penetration depth, laser-welding apparatus 100 can determine the quality of welding based on this measurement result of the depth.

### CITATION LIST

### Patent Literature

PTL 1
Japanese Patent No. 5252026

### SUMMARY OF INVENTION

### Technical Problem

With the above-mentioned traditional configuration, however, there is a problem in that, in a case where oscillations of molten puddle 106 and/or keyhole 107 are large and/or a case where the frequency that a spatter crosses a measurement beam is high, stable measurement cannot be performed because noise becomes large due to the influence of these cases.

FIG. 7 illustrates a result of measurement using measurement beam source 108 in which the change speed (scanning speed) of an optical frequency is approximately 50 P(peta)Hz/second. In FIG. 7, the horizontal axis represents time and the vertical axis represents the depth of a reflection signal, a bright point represents the strength of the reflection signal, and output is gradually lowered in four steps during welding. As illustrated in FIG. 7, large noise occurs in the depth direction, and it is clear that measurement with sufficient accuracy cannot be performed with the traditional configuration.

The present invention is to solve the problem in the related art described above and an object of the present invention is thus to provide a laser-welding apparatus and a laser-welding method each capable of stably measuring a keyhole depth even when oscillations of a molten puddle and/or a keyhole, and/or spatter or the like is present.

### Solution to Problem

To achieve the above object, the present invention provides a laser-welding apparatus including: a laser output section that emits a laser beam toward a welding target member; a measurement beam source that outputs a measurement beam having a wavelength different from that of the laser beam and periodically changes the wavelength of the measurement beam when outputting the measurement beam; an optical member that irradiates a weld part with the laser beam and the measurement beam from the measurement beam source while coaxially overlapping the laser beam and the measurement beam with each other, the weld part being formed in the welding target member by the laser beam; and an optical interferometer that measures a keyhole depth of the weld part based on interference which occurs due to an optical path difference between the measurement beam reflected by the weld part, and a reference beam, in which an average of a scanning speed of an optical frequency in the measurement beam source is greater than or equal to 2000 PHz per second.

### Advantageous Effects of Invention

According to the present invention, a keyhole depth can be accurately measured even when oscillations of a molten puddle and/or a keyhole, and/or spatter or the like is present.

### BRIEF DESCRIPTION OF DRAWINGS

FIG. 1 is a schematic diagram of a laser-welding apparatus in Embodiment 1 of the present invention;

FIG. 2 represents a simulation result of influence of surface movement in keyhole depth measurement;

FIG. 3 represents a result of simulating a measurement error due to influence of surface velocity in a case where a scanning speed of an optical frequency is changed;

FIG. 4 illustrates an actual measurement result of surface movement;

FIG. 5 is a keyhole measurement result in a measurement-light light source of approximately 4,000 PHz/second;

FIG. 6 is a schematic diagram of a traditional laser-welding apparatus described in PTL 1; and

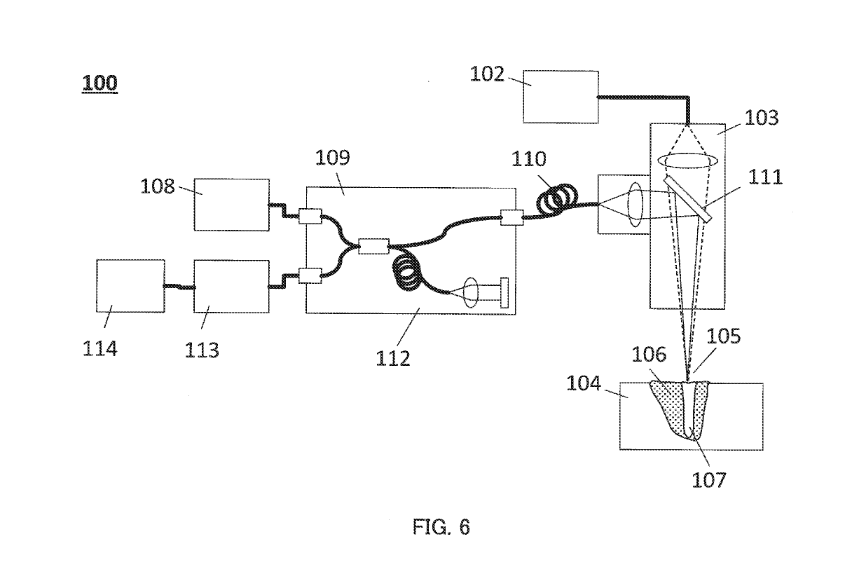

FIG. 7 is a keyhole measurement result in a measurement beam source of approximately 50 PHz/second.

### DESCRIPTION OF EMBODIMENTS

Hereinafter, a detailed description will be given of an embodiment of the present invention with reference to the accompanying drawings.

### Embodiment 1

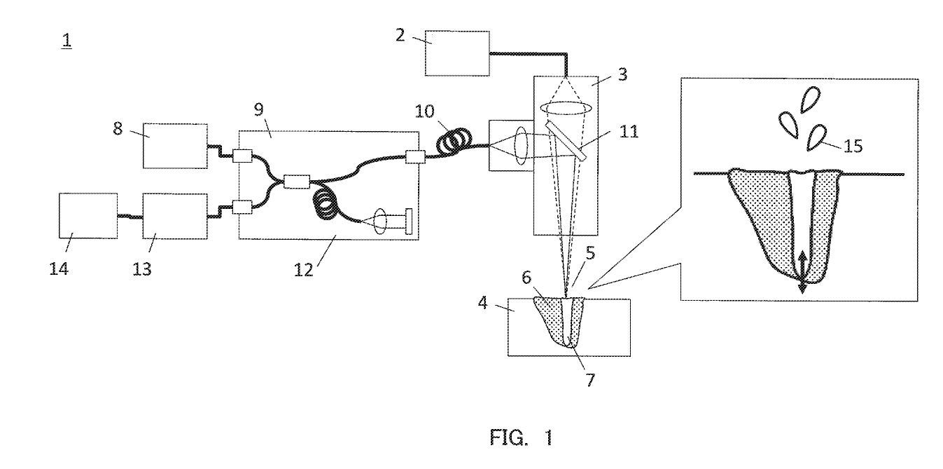

FIG. 1 is a schematic diagram of a laser-welding apparatus in Embodiment 1 of the present invention.

As illustrated in FIG. 1, in laser-welding apparatus 1, a welding laser beam is outputted from laser oscillator 2 and directed to weld part 5 of welding target member 4 via weld head 3 during a welding process. Melting and evaporation from an upper portion of weld part 5 irradiated with the laser beam forms molten puddle 6 which is generated by melting of a metallic member of weld part 5, and also forms keyhole 7 which is a cavity generated by pressure of the vaporized metal.

During this welding process, measurement beam source 8 continuously outputs a measurement beam of a wavelength different from that of a welding laser beam. Measurement beam source 8 periodically changes a center wavelength of the measurement beam to be outputted. Note that, this operation which periodically changes the center wavelength of such a measurement beam is called “wavelength scan” in some cases. The measurement beam is transmitted to weld head 3 via optical fiber 10, and is directed to keyhole 7 of weld part 5 while being concentrically and coaxially overlapped with a welding laser beam by beam splitter 11.

The measurement beam which has been reflected by keyhole 7 is inputted again to optical interferometer 9 via optical fiber 10. In optical interferometer 9, a beam which has passed through reference optical path 12 and the measurement beam which has been reflected by keyhole 7 are combined to form an interference beam. The interference beam is converted by detector 13 into a signal indicating intensity.

Calculator 14 obtains a position where the measurement beam has been reflected by keyhole 7, using the principle of Swept Source Optical Coherence Tomography (SS-OCT: wavelength-scanning optical interference tomography), based on the signal resulting from the conversion by detector 13. This allows a keyhole depth to be measured during a welding process.

In laser-welding apparatus 1 illustrated in FIG. 1, measurement beam source 8 changes an optical frequency which is a reciprocal of a wavelength into a substantially linear shape with respect to time. The change speed (scanning speed) of the optical frequency of measurement beam source 8 is greater than or equal to 2000 PHz/second.

The beam outputted from measurement beam source 8 branches, in optical interferometer 9, into two optical paths: namely, an optical path through which the beam is reflected by weld part 5; and reference optical path 12. The beams resulting from the branching pass through the respective paths and are again combined by optical interferometer 9, and an interference beam resulting from the combining is detected by detector 13. At this time, a time delay occurs between two beams due to an optical path length difference of the two optical paths, and an optical beat of a frequency proportional to this time delay can be obtained. A keyhole depth on the optical axis of the measurement beam can be obtained by performing, using calculator 14, Fourier transformation (FFT) of the optical beat signal detected by detector 13 with linearity between the frequency of the optical beat and the time delay.

The reason for the scanning speed of the optical frequency of measurement beam source 8 being greater than or equal to 2000 PHz/second will be described, herein.

Melted metal at a temperature near a boiling point is present on a surface of keyhole 7, and keyhole 7, which is a cavity, is generated by balance with vaporized metal. As weld head 3 moves, keyhole 7 moves together. For this reason, it is considered that there are many cases where keyhole 7 is not kept in a stable shape and always changes in shape, and a bottom surface of keyhole 7 oscillates. Further, since welding is performed using a laser beam having energy of high peak power is performed in laser welding, excessive energy is added depending on welding conditions, and the metal powder so called spatters 15 may disperse. As described, the measurement accuracy of a keyhole depth may decrease in a case where oscillations occur on the bottom surface of keyhole 7, and/or spatters 15 are generated in the measurement beam emitted from weld head 3.

The result of quantitatively evaluating the influence of oscillations at the bottom surface of keyhole 7 and/or generation of spatters 15 or the like are indicated below.

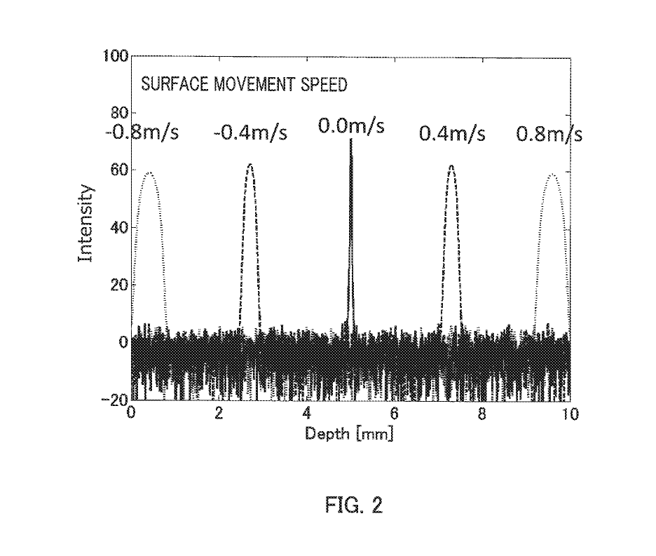

FIG. 2 illustrates a simulation result of the influence on a measurement result of a keyhole depth in a case where the surface (which means the surface of keyhole 7 and/or the surfaces of spatters 15, herein) of weld part 5 moves up and down along the optical axis of a measurement beam at a constant speed. The waveform in which the up and down movement of the surface stops, i.e., the waveform whose moving speed is 0.0 mm/s is the waveform to be measured. As illustrated in FIG. 2, however, as the moving speed of the surface increases, a peak position of a waveform to be measured, i.e., a measurement result of a keyhole depth is shifted.

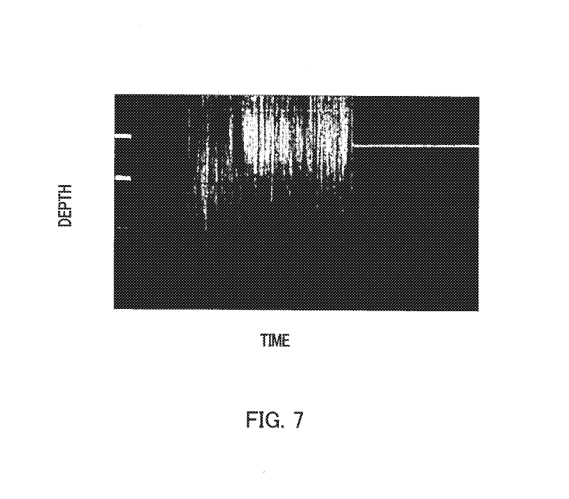

Although the simulation result illustrated to FIG. 2 is a result obtained when the surface moves at a constant speed, but when the moving speed changes irregularly, a measurement result containing a large amount of noise as illustrated in FIG. 7 may be obtained, supposedly.

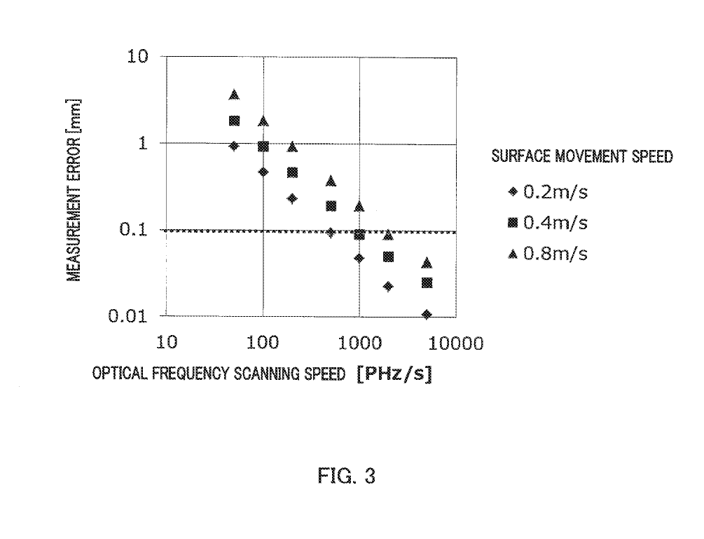

Meanwhile, the influence of oscillations at the bottom surface of keyhole 7 and/or generation of spatters 15 varies depending on an optical frequency scanning speed of measurement beam source 8. The result of simulating a measurement error due to the influence of a surface velocity in a case where a scanning speed of an optical frequency is changed is illustrated in a graph of FIG. 3. As illustrated in FIG. 3, it is observed that the as the scanning speed increases, the measurement errors due to the surface velocity can be reduced.

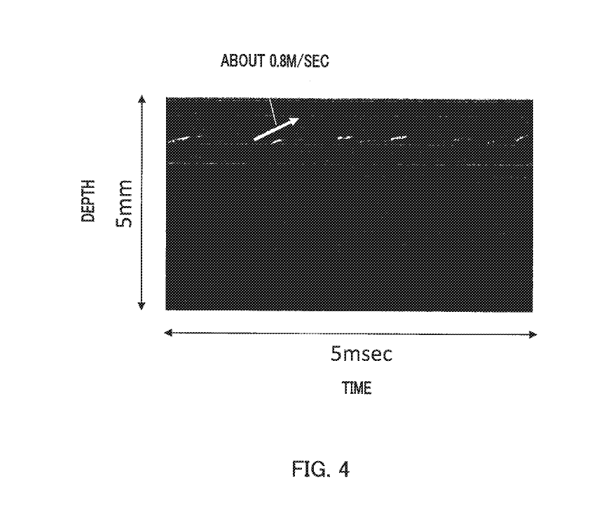

The result of measuring the degree of a moving speed of a surface in actual welding is illustrated in FIG. 4. In FIG. 4, the horizontal axis represent time while the vertical axis represent the depth, and it is observed that the moving speed of a surface becomes about 0.8 m/second at maximum with reference to FIG. 4. More specifically, it can be said that, even when the moving rate of a surface is about 0.8 m/second, stable measurement can be achieved as long as only the influence not greater than a measurement error (accuracy) is received.

Note that, laser welding is often used in automobile-related welding. In automobile-related welding, the depth of welding is in units of mm in many cases. For this reason, automobile-related welding requires about 0.1 mm which is smaller by one digit as the measurement accuracy of a keyhole depth (dotted line in FIG. 3). Thus, when measurement accuracy when the surface velocity is 0.8 m/second as described is required to be less than or equal to 0.1 mm, it can be found, with reference to FIG. 3, that setting the scanning speed of an optical frequency to be at least 2000 PHz/second is sufficient.

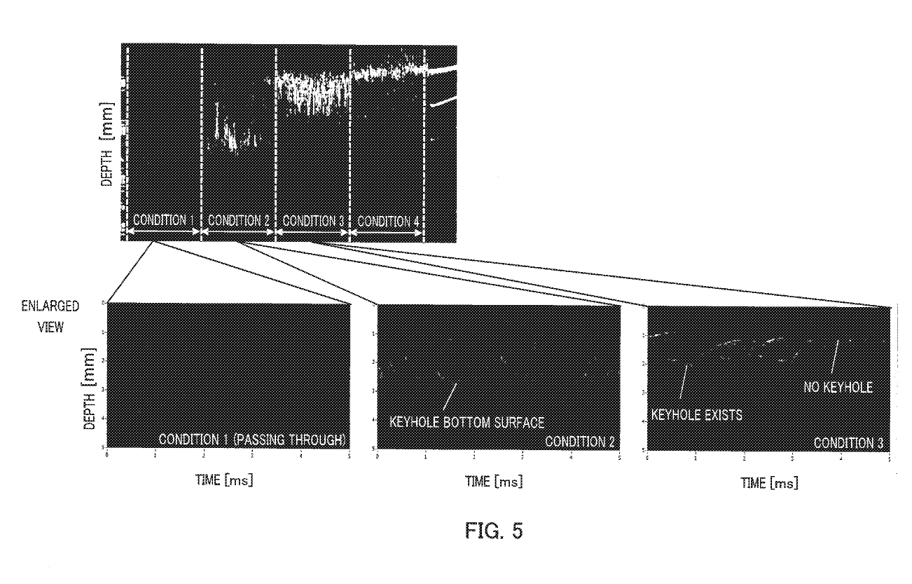

As described, even when oscillations of weld part 5 and/or dispersion of spatters 15 is present, stable measurement of a keyhole depth with less noise can be performed by setting the scanning speed of the optical frequency of measurement beam source 8 to be greater than or equal to 2000 PHz/second. FIG. 5 illustrates a result of performing keyhole measurement using a measurement beam source whose scanning speed of an optical frequency is set to about 4000 PHz/second. It can be confirmed, according to FIG. 5, that the keyhole depth can be stably measured.

Measurement beam source 8 which achieves a scanning speed greater than or equal to 2000 PHz/second can be implemented, for example, using a mirror which operates by MEMS (Micro Electro-Mechanical Systems). Since measurement beam source 8 using an MEMS mirror has a small mass as compared with a beam source using a polygon mirror or the like, measurement beam source 8 using an MEMS mirror can achieve a faster wavelength change. As measurement beam source 8 using an MEMS mirror, there are a beam source in which, for example, a wavelength filter is placed in a resonator and the penetration wavelength of the wavelength filter is continuously changed, and/or a beam source which scans a wavelength by changing a resonator length by a mirror which operates by an MEMS, using VCSEL (Vertical Cavity Surface Emitting Laser) as a gain medium.

Note that, in the present embodiment, although a beam source of MEMS type is used as measurement beam source 8, which achieves a scanning speed greater than or equal to 2000 PHz/second, a beam source using a DBR (Distributed Bragg Reflector) laser may be used, for example. A DBR laser changes an injection current to cause refractive-index change with a career effect and changes an optical path length of a resonator to change a wavelength. The refractive-index change due to a change in injection current is fast, and since no mechanical operation is involved, a very fast wavelength change is achievable.

### INDUSTRIAL APPLICABILITY

The laser-welding apparatus and the laser-welding method of the present invention can be applied to laser welding for automobiles and/or electronic components or the like.

### REFERENCE SIGNS LIST

1 Laser-welding apparatus
2 Laser oscillator
3 Weld head
4 Welding target member
5 Weld part
6 Molten puddle
7 Keyhole
8 Measurement beam source
9 Optical interferometer
10 Optical fiber
11 Beam splitter
12 Reference optical path
13 Detector
14 Calculator
15 Spatter
100 Laser-welding apparatus
102 Laser oscillator
103 Weld head
104 Welding target member
105 Weld part
106 Molten puddle
107 Keyhole
108 Measurement beam source
109 Optical interferometer
110 Optical fiber
111 Beam splitter
112 Reference optical path
113 Detector
114 Calculator

1. A laser-welding apparatus, comprising:
a laser output section that emits a laser beam toward a welding target member;
a measurement beam source that outputs a measurement beam having a wavelength different from that of the laser beam and periodically changes the wavelength of the measurement beam when outputting the measurement beam;
an optical member that irradiates a weld part with the laser beam and the measurement beam from the measurement beam source while coaxially overlapping the laser beam and the measurement beam with each other, the weld part being formed in the welding target member by the laser beam; and
an optical interferometer that measures a keyhole depth of the weld part based on interference which occurs due to an optical path difference between the measurement beam reflected by the weld part, and a reference beam, wherein
an average of a scanning speed of an optical frequency in the measurement beam source is greater than or equal to 2000 PHz per second.

2. The laser-welding apparatus according to claim 1, wherein
the measurement beam source is a beam source that scans a wavelength by an operation of an MEMS mirror.

3. The laser-welding apparatus according to claim 1, wherein
the measurement beam source is a semiconductor laser that scans a wavelength by an injection current.

4. A laser-welding method, comprising:
emitting a laser beam toward a welding target member;
outputting a measurement beam having a wavelength different from that of the laser beam and periodically changing the wavelength of the measurement beam when outputting the measurement beam;
irradiating a weld part with the laser beam and the measurement beam from the measurement beam source while coaxially overlapping the laser beam and the measurement beam with each other, the weld part being formed in the weld target member by the laser beam; and
measuring a keyhole depth of the weld part based on interference which occurs due to an optical path difference between the measurement beam reflected by the weld part, and a reference beam, wherein
an average of a change speed of an optical frequency in the outputting of the measurement beam is greater than or equal to 2000 PHz per second in the outputting of the measurement beam.
